(19) United States
(12) Patent Application Publication
(10) Pub. No.: US 2009/0229776 A1
(43) Pub. Date: Sep. 17, 2009

(54) TEMPORARY WET STRENGTH AGENTS AND PRODUCTS MADE FROM SUCH AGENTS

(75) Inventors: Naijie Zhang, Ridgefield, CT (US); Michael Ryan, Newtown, CT (US)

Correspondence Address: CANTOR COLBURN, LLP, 20 Church Street, 22nd Floor, Hartford, CT, 06103, US

(73) Assignee: KEMIRA OYJ, Helsinki (FI)

(21) Appl. No.: 11/577,602

(22) PCT Filed: Sep. 26, 2005
(86) PCT No.: PCT/US05/34373

§ 371 Date: Jun. 4, 2009

Related U.S. Application Data
(60) Provisional application No. 60/620,567, filed on Oct. 20, 2004.

(51) Int. Cl. D21H 17/55; D21H 17/00; C09D 191/06; C09D 1/00; C09D 7/12

(52) U.S. Cl. 162/164.6; 162/158; 106/270; 106/286.8; 106/287.24

(57) ABSTRACT

The invention relates to a tissue product comprising (a) tissue fibrous web incorporated throughout the tissue product; (b) a temporary wet strength agent capable of forming hemi-acetal bonds with the fibers of the web to prevent immediate degradation of the web when the tissue product contacts water; and (c) a composition containing a degrading agent selected from the group consisting of alkaline agents, oxidizing agents, nucleophilic agents, and combinations thereof; such that the tissue product has at least one surface and the degrading agent is located substantially throughout the surface of the fibrous web in an amount sufficient to make the fibrous web exhibit (i) an immediate wet tensile strength of at least 90% of the wet strength as compared to a web that does not contain a degrading agent and (ii) a wet soak decay that is at least a ten point improvement as compared to a tissue fibrous web that does not contain a degrading agent. The invention also relates to compositions for making the product, methods for making the composition, and methods for using the composition.

### BACKGROUND OF THE INVENTION

The tissue industry has had a long-felt need for a very high decaying temporary wet strength agent. Poor decay translates into the clogging of pipes and septic systems. While many consumers desire wet strength in their tissue, there are consumers who do not use tissue with a temporary wet strength agent due to this problem. A tissue with high initial wet strength and outstanding decay would have a very significant benefit for consumers.

The tissue industry has also had a long-felt need for a temporary wet strength agent that can exhibit very high initial wet tensile. Having a composition that would achieve this objective would allow the paper-maker to use low dosages of this temporary wet strength agent and still achieve acceptable decay resulting in significant cost savings. Having a composition that produces tissue that exhibits both high decay and a high initial wet strength would provide numerous benefits to both consumers and papermakers.

Unfortunately, current known temporary wet strength agents have not been able to provide a temporary wet strength agent that is high decaying and that exhibits a very high initial wet tensile. U.S. Pat. No. 6,548,427, for instance, teaches the addition of a temporary wet strength agent, such as glyoxylated polyacrylamide, to a tissue product during the wet end of a tissue manufacturing process and the subsequent addition of an alkaline reagent to the tissue product during the dry end of the manufacturing process. The patent does not provide meaningful guidelines to enable one or ordinary skill in the art to make a tissue with high initial wet strength and outstanding decay. The use of sodium bicarbonate, discussed in Example 2 of U.S. Pat. No. 6,548,427, for instance, has been found to be inadequate in producing a tissue with high initial wet strength and outstanding decay. This patent does not teach how to achieve a tissue product having very high decaying, temporary wet strength agent, let alone a tissue product having an immediate wet tensile strength of at least 90% of the wet strength as compared to a web that does not contain a degrading agent and a wet soak decay that is at least a ten point improvement as compared to a tissue fibrous web that does not contain a degrading agent.

For the foregoing reasons, there is a need to develop a tissue product that exhibits improved decay.

For the foregoing reasons, there is a need to develop a tissue product that exhibits an immediate wet tensile strength of at least 90% as compared to the immediate wet tensile strength of a web that does not contain a degrading agent.

For the foregoing reasons, there is a need to develop a tissue product that exhibits a wet soak decay that is at least a ten point improvement as compared to a tissue fibrous web that does not contain a degrading agent.

### SUMMARY OF THE INVENTION

The invention relates to a tissue product including: (a) a tissue fibrous web incorporated throughout the tissue product; (b) a temporary wet strength agent capable of forming hemi-acetal bonds with the fibers of the web to prevent immediate degradation of the web when the tissue product contacts water; and (c) a composition containing a degrading agent selected from the group consisting of alkaline agents, oxidizing agents, nucleophilic agents, and combinations thereof. The tissue product has at least one surface and the degrading agent is located substantially throughout the surface of the fibrous web. The degrading agent is present throughout the surface of the tissue product in an amount sufficient to make the fibrous web exhibit (i) an immediate wet tensile strength of at least 90% of the wet strength as compared to a web that does not contain a degrading agent and (ii) a wet soak decay that is at least a ten point improvement as compared to a tissue fibrous web that does not contain a degrading agent.

In one embodiment, the invention provides a tissue having an absorbent fibrous cellulosic web, wherein the tissue includes a combination of the following properties:

(1) a total area ranging from 100 to 150 cm²;
(2) a basis weight ranging from 5 to 50 gsm;
(3) a degrading agent located throughout the surface of the fibrous cellulosic web, such that the degrading agent is selected from the group consisting of alkaline agents, oxidizing agents, nucleophilic agents, and combinations thereof;
(4) an immediate wet tensile strength of at least 90% of the wet strength as compared to a web that does not contain a degrading agent and
(5) a wet soak decay that is at least a ten point improvement as compared to a tissue fibrous web that does not contain a degrading agent.

In another embodiment, the invention relates to a composition including a tissue having an absorbent fibrous cellulosic web, wherein the tissue includes a combination of:

(1) a total area ranging from 100 to 150 cm²;
(2) a basis weight ranging from 5 to 50 gsm;
(4) an initial wet tensile strength that is at least 10 g/cm²;
(3) an improved decay that is at least 10 points;
(4) an absorbency that is less than 25 seconds, as measured by the water drop test.

In one embodiment, the invention relates to a composition comprising a formulation including:

(a) a degrading agent selected from the group consisting of alkaline agents, oxidizing agents, nucleophilic agents, and combinations thereof; and

(b) a degradation inhibiting carrier component;

wherein the degrading agent is present substantially throughout the surface of the tissue product in a sufficient amount to make a tissue fibrous web surface containing the composition exhibit (i) an immediate wet tensile strength of at least 90% of the wet strength as compared to a web surface that does not contain a degrading agent composition and (ii) a wet soak decay that is at least a ten point improvement as compared to a tissue fibrous web that does not contain a degrading agent composition.

These and other features, aspects, and advantages of the present invention will become better understood with reference to the following description and appended claims.

### DESCRIPTION OF THE INVENTION

The invention is based on the discovery that by adding a composition containing a degrading agent selected from the group consisting of alkaline agents, oxidizing agents, nucleophilic agents, and combinations thereof to the surface of a tissue fibrous web in a tissue making process that uses a temporary wet strength agent at the wet end (pulp slurry), it is now possible to make a tissue fibrous web exhibit (i) an immediate wet tensile strength of at least 90% of the wet strength as compared to a web that does not contain a degrading agent and (ii) a wet soak decay that is at least a ten point improvement as compared to a tissue fibrous web that does not contain the degrading agent. The phrase “a ten point improvement,” refers to the difference between the initial wet tensile and thirty minute wet soak tensile as a percentage of initial wet tensile is at least ten full points or greater using the invented technology, e.g. 80% vs. 70% wet tensile decay in thirty minutes. The phrase “the water drop test” refers to the time, measured in seconds, for a 5 microliter drop of water to absorb into a sheet of paper.

Other than in the operating examples or where otherwise indicated, all numbers or expressions referring to quantities of ingredients, reaction conditions, and the like, used in the specification and claims are to be understood as modified in all instances by the term “about”. Various numerical ranges are disclosed in this patent application. Because these ranges are continuous, they include every value between the minimum and maximum values. Unless expressly indicated otherwise, the various numerical ranges specified in this application are approximations.

The temporary wet strength suitable for the invention can be any temporary wet strength agent capable of forming hemi-acetal bonds with the fibers of the web to provide initial wet strength in the fibrous sheet and to prevent immediate degradation of the web when the tissue product contacts water. The temporary wet strength agent component, for instance, can be selected from the group of the following temporary wet strength agents: dialdehyde starch, glyoxylated polyacrylamides, and combinations thereof. In one embodiment, the temporary wet strength agent is a glyoxylated polyacrylamide having a backbone that is less than 10,000 daltons prior to glyoxylation.

The amounts of the temporary wet strength agent can vary, depending on the application. In one embodiment, the temporary wet strength agent is in an amount that is at least 0.05 wt %, based on the weight of the dry fiber. In another embodiment, the temporary wet strength agent is in an amount that is at least 0.1 wt %, based on the weight of the dry fiber. In another embodiment, the temporary wet strength agent is present in an amount ranging from 0.05 to 1.0 wt %, based on the weight of the dry fiber.

The degrading agent is generally selected from the group of alkaline agents, oxidizing agents, nucleophilic agents, and combinations thereof. Examples of suitable degrading agents include and are not limited to Mg(OH)₂, Ca(OH)₂, Mg(HSO₃)₂, MgO₂, ZnO, Na₂SO₃, (MgCO₃)₄. Mg(OH)₂, Na₂O.Al₂O₃, H₂O₂, and combinations thereof. In one embodiment, the alkaline reagent component excludes sodium acetate, sodium benzoate, sodium carbonate, sodium bicarbonate, calcium carbonate, calcium bicarbonate, and combinations thereof.

The degradation inhibiting carrier prevents the degrading agent from lowering the initial wet tensile such that the degradation inhibiting carrier delays the action of the degrading agent to yield high initial wet tensile and high decay. The degradation inhibiting carrier may be described as a hydrophobic carrier, e.g., a protective hydrophobic liquid vehicle, that allows the degrading agent to lower the wet soak tensile, thereby improving the decay.

The degradation inhibiting carrier can be a surfactant having an HLB value that is more than 3 and less than 18. Alternatively, the degradation inhibiting carrier can include lotions that include mixtures containing materials selected from the following: water, mineral oil, petrolatum, sorbitol, stearic acid, lanolin, lanolin alcohol, cetyl alcohol, glyceryl stearate, PEG-100 stearate, triethanolamine, dimethicone, propylene glycol, microcrystalline wax, triethyl citrate, PPG-3 myristyl ether, disodium EDTA, methylparaben, ethylparaben, propylparaben, fragrance, xanthan gum, butylparaben, methyldibromo glutaronitrile. Lotions containing the following materials can also be used: a mixture of water, glycerin, sodium myristoyl sarcosina, PEG-120 methyl glucose dioleate, sodium lauroamphoacetate, disodium lauroamphoacetate, glycol distearate, PEG-150 pentaerithritol tetra stearate, sodium tridecethsulfate, polyquaternium-10, sodium laureth sulfate, phenoxyethanol, cocamide mea, citric acid, DADM hydantoin, disodium EDTA, laureth-10, fragrance. In one embodiment, a cream containing materials selected from the following can be used: a mixture of water, sodium C₁₄₋₁₆ olefin sulfonate, cocamidopropyl betaine, cetyl alcohol, stearyl alcohol, di-C-₁₂₋₁₅ alkyl fumarate, coco-glucoside, coconut alcohol, sodium methyl cocoyl taurate, DEA-cetyl phosphate, matriciaria (chamomilla recutita) flower extract, aloe barbadensis leaf extract, chamonile (anthemis nobiiis) flower extract, hydroxypropyl methylcellulose, potato (sodium tuberosum) starch, propylene glycol, fragrance. In another embodiment, a cream containing the following materials can be used: a mixture of water, sodium cocoyl isethionate, propylene glycol, stearic acid, cetearyl alcohol, cocoamidopropyl betaine, hydroxypropyl methylcellulose, sodium lauroyl sarcosinate, salicylic acid, menthol, fragrance, magnesium aluminum silicate, disodium EDTA, methylparaben, propylparaben, DADM hydantonin, titanium dioxide (CI 77891). Alternatively, the following materials may also be suitable: Tetra-alkyl ammonium chloride, quaternary amine tetra alkyl ammonium chloride, sodium dioctyl sulfosuccinate in petroleum distillate, polyoxyethylene(10) oleyl ether Polyoxyethylene(2) cetyl ether. Examples of commercially available materials can be selected from the group of Aerosol OT, Variquat K1215, Suave Cream, Neutragena Cream, Olay lotion, tissue softener, Brij 97, Brij 52, solid wax coatings, other such protective hydrophobic liquid vehicles, and combinations thereof.

The composition containing the degrading agent is specifically designed to be used to make tissue products having a combination of useful immediate wet tensile strength and wet soak decay properties. Generally, the composition containing the degrading agent component includes (i) a liquid degradation inhibiting carrier and (ii) a degrading agent component selected from the group consisting of oxidizing agents, alkaline agents, nucleophilic agents, and combinations thereof. In one embodiment, the degrading agent component is liquid. In another embodiment, the degrading agent is a solid moiety suspended in liquid particles. As such, the composition containing the degrading agent includes a carrier including (1) a suspended component selected from the group consisting of alkaline agents, oxidizing agents, nucleophilic agents, and combinations thereof and a (2) a hydrophobic carrier that surrounds at least a portion of the suspended component. The temperatures at which a composition of the invention is made or used varies with application.

The pulp slurry that is treated with a composition of the invention generally includes any pulp slurry, which when used in accordance to the invention, produces tissue that exhibits (i) improved initial wet tensile, (ii) high decay. Suitable fibers provide sufficient sheet integrity to make tissue products suitable for their ordinary use. Papermaking fibers for making the tissue product webs of this invention, for instance, can include any natural or synthetic fibers suitable for the end use products listed above including, but not limited to: non-wood fibers, such as abaca, sabai grass, milkweed floss fibers, pineapple leaf fibers; softwood fibers, such as northern and southern softwood kraft fibers; hardwood fibers, such as eucalyptus, maple, birch, aspen, or the like. In addition, furnishes including recycled fibers may also be utilized. In making the tissue products, the fibers are formed into a pulp furnish by known pulp stock formation processes.

Softening agents, sometimes referred to as debonders, can be added to the tissue making process to enhance the softness of the tissue product. Such softening agents can be incorporated with the fibers before, during or after dispersing the fibers in the furnish. Such agents can also be sprayed or printed onto the web after formation, while wet, or added to the wet end of the tissue machine prior to formation. Suitable softening agents include, without limitation, fatty acids, waxes, quaternary ammonium salts, dimethyl dihydrogenated tallow ammonium chloride, quaternary ammonium methyl sulfate, carboxylated polyethylene, cocamide diethanol amine, coco betane, sodium lauryl sarcosinate, partly ethoxylated quaternary ammonium salt, distearyl dimethyl ammonium chloride, polysiloxanes and the like. Examples of suitable commercially available chemical softening agents include, without limitation, Berocell 596 and 584 (quaternary ammonium compounds) manufactured by Eka Nobel Inc., Adogen 442 (dimethyl dihydrogenated tallow ammonium chloride) manufactured by Sherex Chemical Company, Quasoft 203 (quaternary ammonium salt) manufactured by Quaker Chemical Company, and Arquad 2HT-75 (di (hydrogenated tallow) dimethyl ammonium chloride) manufactured by Akzo Chemical Company. Suitable amounts of softening agents will vary greatly with the species of pulp selected and the desired characteristics of the resulting tissue product. Such amounts can be, without limitation, from 0.05 to 1 weight percent based on the weight of fiber, more specifically from 0.25 to 0.75 weight percent, and still more specifically 0.5 weight percent.

The tissue pulp slurry generally does not contain an appreciable amount of permanent wet strength agent. In one embodiment, the pulp slurry contains a permanent wet strength resin in an amount that is less than 250 ppm. In another embodiment, the pulp slurry contains a permanent wet strength resin in an amount that is less than 100 ppm. In another embodiment, the pulp slurry does not contain any permanent wet strength resin.

In use, the invention provides a highly effective method for making paper having a combination of highly useful properties. The temporary vvet strength agent is added to the wet end and the composition containing a degrading agent are added to the surface of a tissue fibrous web.

One way that such a method may be practiced includes a method that involves the steps of (1) adding to a tissue pulp slurry a composition comprising a temporary wet strength agent component capable of forming hemi-acetal bonds with the fibers of a tissue web to provide initial wet strength and subsequent rapid degradation of the initial wet strength when the tissue web contacts water, the temporary wet strength agent being present in an amount ranging from 0.05 to 1.0 wt %, based on the weight of the dry fiber; and (2) adding to a surface of a tissue fibrous web, a composition containing a degrading agent selected from the group consisting of alkaline agents, oxidizing agents, nucleophilic agents, and combinations thereof, and thereby making a tissue paper product that has a combination of highly useful properties.

A tissue product made from the process of the invention has high ly useful properties. The degrading agent is located substantially throughout the surface of the fibrous web formed by the process. The degrading agent is present on the surface of the tissue product in an amount that is sufficient to make the fibrous web exhibit (i) an immediate wet tensile strength of at least 90% of the wet strength as compared to a web that does not contain a degrading agent and (ii) a wet soak decay that is at least a ten point improvement as compared to a tissue fibrous web that does not contain a degrading agent. The improved decay provided by the system means that the risk of clogging of pipes and septic systems is reduced. While many consumers desire wet strength in their tissue, there are consumers who do not use tissue with a temporary wet strength agent due to this problem. The tissue made in accordance to the invention exhibits both high initial decay and a high initial wet strength would provide numerous benefits to both consumers and papermakers.

In one embodiment, the invention provides a tissue having an absorbent fibrous cellulosic web, wherein the tissue includes a combination of the following properties:

(1) a total area ranging from 100 to 150 cm²;
(2) a basis weight ranging from 5 to 50 gsm;
(3) a degrading agent located throughout the surface of the fibrous cellulosic web, such that the degrading agent is selected from the group consisting of alkaline agents, oxidizing agents, nucleophilic agents, and combinations thereof;
(4) an immediate wet tensile strength of at least 90% of the wet strength as compared to a web that does not contain a degrading agent and
(5) a wet soak decay that is at least a ten point improvement as compared to a tissue fibrous web that does not contain a degrading agent.

In another embodiment, the invention relates to a composition including a tissue having an absorbent fibrous cellulosic web, wherein the tissue includes a combination of:

(1) a total area ranging from 100 to 150 cm²;
(2) a basis weight ranging from 5 to 50 gsm;
(4) an initial wet tensile strength that is at least 10 g/cm²;
(3) an improved decay that is at least 10 points;
(4) an absorbency that is less than 25 seconds, as measured by the water drop test.

In one embodiment, the absorbency is less than 20 seconds or less than 15 seconds. In another embodiment, the absorbency is less than 10 seconds. In another embodiment, the absorbency is less than 5 seconds. In another embodiment, the absorbency is less than 2 seconds. In another embodiment, the absorbency ranges from 1 to 2, 5, 10, 15, 20, or 25 seconds. With respect to the improved decay, in one embodiment, the improved decay is at least 15 points. In another embodiment, the improved decay is at least 18 points or at least 20 points. In another embodiment, the improved decay ranges from 10 to 20 points.

The invention is further described in the following illustrative examples in which all parts and percentages are by weight unless otherwise indicated.

### Example 1

Wet tensile of a standard commercial premium toilet tissue containing wet strength was measured using a Finch cup attachment to the Thwing-Albert tensile tester. Initial wet tensile and five minute soak tensile was measured on these 2.5 cm by 10.2 cm sample strips.

### Example 2

The same standard commercial premium toilet tissue used in Example 1 was treated as follows. A stable emulsion of calcium hydroxide in a liquid oil and surfactant blend was applied to the tissue surface by roller. The addition rate of the modified lotion is 0.4% based on tissue weight. The treated toilet tissue was measured using a Finch cup attachment to the Thwing-Albert tensile tester. Initial wet tensile and five minute soak tensile was measured on these 2.5 cm by 10.2 cm sample strips.

### RESULTS

| Example | Initial Wet Tensile (g/cm) | % Decay (5 min) |
|---|---|---|
| 1 | 34 | 38 |
| 2 | 34 | 73 |

Although the present invention has been described in detail with reference to certain preferred versions thereof, other variations are possible. Therefore, the spirit and scope of the appended claims should not be limited to the description of the versions contained therein.

What is claimed is:

1. A tissue product comprising:
(a) a tissue fibrous web incorporated throughout the tissue product;
(b) a temporary wet strength agent capable of forming hemi-acetal bonds with the fibers of the web to prevent immediate degradation of the web when the tissue product contacts water; and
(c) a composition containing a degrading agent selected from the group consisting of alkaline agents, oxidizing agents, nucleophilic agents, and combinations thereof;
wherein the tissue product has at least one surface and the degrading agent is located substantially throughout the surface of the fibrous web in an amount sufficient to make the fibrous web exhibit (i) an immediate wet tensile strength of at least 90% of the wet strength as compared to a web that does not contain a degrading agent and (ii) a wet soak decay that is at least a ten point improvement as compared to a tissue fibrous web that does not contain a degrading agent.

2. The tissue product of claim 1 wherein the temporary wet strength agent is a glyoxylated polyacrylamide.

3. The tissue product of claim 2, wherein the glyoxylated polyacrylamide is added at an amount of from about 0.05% to about 1.0% by dry weight of the fibrous web.

4. The tissue product of claim 1, wherein the composition containing the degrading agent component comprises (i) a liquid degradation inhibiting carrier and (ii) a degrading agent component selected from the group consisting of oxidizing agents, nucleophilic agents, alkaline agents, and combinations thereof.

5. The tissue product of claim 4, wherein the carrier is a surfactant having an HLB value that is more than 3 and less than 18.

6. The tissue product of claim 5, wherein the carrier is selected from the group consisting of (1) mixtures containing materials selected from the group consisting of water, mineral oil, petrolatum, sorbitol, stearic acid, lanolin, lanolin alcohol, cetyl alcohol, glyceryl stearate, PEG-100 stearate, triethanolamine, dimethicone, propylene glycol, microcrystalline wax, triethyl citrate, PPG-3 myristyl ether, disodium EDTA, methylparaben, ethylparaben, propylparaben, fragrance, xanthan gum, butylparaben, methyldibromo glutaronitrile, and combinations thereof, (2) lotions containing the following materials selected from the group consisting of water, glycerin, sodium myristoyl sarcosina, PEG-120 methyl glucose dioleate, sodium lauroamphoacetate, disodium lauroamphoacetate, glycol distearate, PEG-150 pentaerithritol tetra stearate, sodium tridecethsulfate, polyquaternium-10, sodium laureth sulfate, phenoxyethanol, cocamide mea, citric acid, DADM hydantoin, disodium EDTA, laureth-10, fragrance, and combinations thereof, (3) creams containing materials selected from the group consisting of water, sodium C₁₄₋₁₆ olefin sulfonate, cocamidopropyl betaine, cetyl alcohol, stearyl alcohol, di-C₁₂₋₁₅ alkyl fumarate, coco-glucoside, coconut alcohol, sodium methyl cocoyl taurate, DEA-cetyl phosphate, matriciaria (chamomilla recutita) flower extract, aloe barbadensis leaf extract, chamonile (anthemis nobiiis) flower extract, hydroxypropyl methylcellulose, potato (sodium tuberosum) starch, propylene glycol, fragrance, and combinations thereof, (4) creams containing materials selected from the group consisting of water, sodium cocoyl isethionate, propylene glycol, stearic acid, cetearyl alcohol, cocoamidopropyl betaine, hydroxypropyl methylcellulose, sodium lauroyl sarcosinate, salicylic acid, menthol, fragrance, magnesium aluminum silicate, disodium EDTA, methylparaben, propylparaben, DADM hydantonin, titanium dioxide (CI77891), and combinations thereof, (5) Tetra-alkyl ammonium chlorides, (6) quaternary amine tetra alkyl ammonium chlorides, (7) sodium dioctyl sulfosuccinates in petroleum distillates, (8) polyoxyethylene(10) oleyl ethers, (9) polyoxyethylene(2) cetyl ethers, and combinations thereof.

7. The tissue product of claim 1, wherein the liquid degradation inhibiting carrier is hydrophobic.

8. The tissue product of claim 7, wherein the degrading agent component is liquid.

9. The tissue product of claim 7, wherein the degrading agent is a solid moiety suspended in liquid particles.

10. The tissue product of claim 1, wherein the alkaline reagent component excludes sodium acetate, sodium benzoate, sodium carbonate, sodium bicarbonate, calcium carbonate, calcium bicarbonate, and combinations thereof.

11. In a process for forming a tissue product from a tissue fibrous web that uses a temporary wet strength agent, the improvement comprising the addition to a surface of the tissue product of a composition containing a degrading agent selected from the group consisting of alkaline agents, oxidizing agents, nucleophilic agents, and combinations thereof;
wherein the degrading agent is located substantially throughout the surface of the fibrous web formed by the process in an amount that is sufficient to make the fibrous web exhibit (i) an immediate wet tensile strength of at least 90% of the wet strength as compared to a web that does not contain a degrading agent composition and (ii) a wet soak decay that is at least a ten point improvement as compared to a tissue fibrous web that does not contain a degrading agent composition.

12. A composition comprising a formulation including:
(a) a degrading agent selected from the group consisting of alkaline agents, oxidizing agents, nucleophilic agents, and combinations thereof; and
(b) a degradation inhibiting carrier component;
wherein the degrading agent is present throughout the surface of the tissue product in a sufficient amount to make a tissue fibrous web surface containing the composition exhibit (i) an immediate wet tensile strength of at least 90% of the wet strength as compared to a web surface that does not contain a degrading agent composition and (ii) a wet soak decay that is at least a ten point improvement as compared to a tissue fibrous web that does not contain a degrading agent composition.

13. The composition of claim 12, wherein the degradation inhibiting carrier component is selected from the group consisting of oxidizing agents, nucleophilic agents, and combinations thereof.

14. The composition of claim 12, wherein the carrier is selected from the group consisting of (1) mixtures containing materials selected from the group consisting of water, mineral oil, petrolatum, sorbitol, stearic acid, lanolin, lanolin alcohol, cetyl alcohol, glyceryl stearate, PEG-100 stearate, triethanolamine, dimethicone, propylene glycol, microcrystalline wax, triethyl citrate, PPG-3 myristyl ether, disodium EDTA, methylparaben, ethylparaben, propylparaben, fragrance, xanthan gum, butylparaben, methyldibromo glutaronitrile, and combinations thereof, (2) lotions containing the following materials selected from the group consisting of water, glycerin, sodium myristoyl sarcosina, PEG-120 methyl glucose dioleate, sodium lauroamphoacetate, disodium lauroamphoacetate, glycol distearate, PEG-150 pentaerithritol tetra stearate, sodium tridecethsulfate, polyquaternium-10, sodium laureth sulfate, phenoxyethanol, cocamide mea, citric acid, DADM hydantoin, disodium EDTA, laureth-10, fragrance, and combinations thereof, (3) creams containing materials selected from the group consisting of water, sodium C₁₄₋₁₆ olefin sulfonate, cocamidopropyl betaine, cetyl alcohol, stearyl alcohol, di-C-₁₂₋₁₅ alkyl fumarate, coco-glucoside, coconut alcohol, sodium methyl cocoyl taurate, DEA-cetyl phosphate, matriciaria (chamomilla recutita) flower extract, aloe barbadensis leaf extract, chamonile (anthemis nobiiis) flower extract, hydroxypropyl methylcellulose, potato (sodium tuberosum) starch, propylene glycol, fragrance, and combinations thereof, (4) creams containing materials selected from the group consisting of water, sodium cocoyl isethionate, propylene glycol, stearic acid, cetearyl alcohol, cocoamidopropyl betaine, hydroxypropyl methylcellulose, sodium lauroyl sarcosinate, salicylic acid, menthol, fragrance, magnesium aluminum silicate, disodium EDTA, methylparaben, propylparaben, DADM hydantonin, titanium dioxide (CI 77891), and combinations thereof, (5) Tetra-alkyl ammonium chlorides, (6) quaternary amine tetra alkyl ammonium chlorides, (7) sodium dioctyl sulfosuccinates in petroleum distillates, (8) polyoxyethylene(10) oleyl ethers, (9)polyoxyethylene(2) cetyl ethers, and combinations thereof.

15. A composition comprising a tissue having an absorbent fibrous cellulosic web having a surface, wherein the tissue includes a combination of:
(1) a total area ranging from 100 to 150 cm²;
(2) a basis weight ranging from 5 to 50 gsm;
(3) a degrading agent located throughout the surface of the fibrous cellulosic web, wherein the degrading agent is selected from the group consisting of alkaline agents, oxidizing agents, nucleophilic agents, and combinations thereof
(4) an immediate wet tensile strength of at least 90% of the wet strength as compared to a web that does not contain a degrading agent and
(5) a wet soak decay that is at least a ten point improvement as compared to a tissue fibrous web that does not contain a degrading agent.

16. A composition comprising a tissue having an absorbent fibrous cellulosic web, wherein the tissue includes a combination of:
(1) a total area ranging from 100 to 150 cm²;
(2) a basis weight ranging from 5 to 50 gsm;
(4) an initial wet tensile strength that is at least 10 g/cm²;
(3) an improved decay that is at least 10 points;
(4) an absorbency that is less than 25 seconds, as measured by the water drop test.
